(19) United States
(12) Patent Application Publication
(10) Pub. No.: US 2010/0302113 A1
(43) Pub. Date: Dec. 2, 2010

(54) In-vehicle antenna device

(75) Inventors: Yuji Sugimoto, Kariya-city (JP); Kiyokazu Akiyama, Okazaki-city (JP); Michio Shamoto, Konan-city (JP)

Correspondence Address: HARNESS, DICKEY & PIERCE, P.L.C., P.O. BOX 828, BLOOMFIELD HILLS, MI, 48303, US

(73) Assignees: DENSO CORPORATION, Kariya-city (JP); Nippon Soken, Inc., Nishio-city (JP)

(21) Appl. No.: 12/800,660

(22) Filed: May 20, 2010

(30) Foreign Application Priority Data
May 28, 2009 (JP) 2009-128965

(51) Int. Cl. H01Q 1/32

(52) U.S. Cl. 343/713

(57) ABSTRACT

An in-vehicle antenna device includes: a dielectric element having a front surface, first and second side surfaces and a rear surface and including a power supply point on both the first and second side surfaces, a first conductive surface on the first side surface, a second conductive surface on the second side surface, and a third conductive surface on the rear surface; and an antenna element including a base element coupled with the power supply point at one corner of the front surface and a branch element connected to the base element and having an end. A part of the branch element moves apart from one of the first and second conductive surfaces as it goes from the base element to the one end of the branch element. The front surface is attached to a windshield of a vehicle.

### CROSS REFERENCE TO RELATED APPLICATION

This application is based on Japanese Patent Application No. 2009-128965 filed on May 28, 2009, the disclosure of which is incorporated herein by reference.

### FIELD OF THE INVENTION

The present invention relates to an in-vehicle antenna device.

### BACKGROUND OF THE INVENTION

A film antenna as an in-vehicle antenna mounted on a vehicle is disclosed in JP-B2-4064978 corresponding to US Patent Application Publication No. 2005/0264461. The film antenna is arranged on and attached to a wind shield glass of the vehicle near a corner, at which a roof of a body and a pillar cross. Further, a technique for increasing a gain of an antenna having double loop shape is disclosed in JP-A-2008-113407. In the technique, a reflection element is arranged on a rear side of the antenna element.

The film antenna can be attached to a predetermined position of the windshield, which does not hinder front vision of a driver of the vehicle. Thus, the vision of the driver in front of the vehicle is secured. However, in this case, the film antenna transmits an electro-magnetic wave not only toward an outside of a compartment of the vehicle but also toward an inside of the compartment. Thus, when a communication device is disposed in the compartment, and the communication device uses the same communication frequency zone as the film antenna, the electro-magnetic wave from the film antenna may affect operation of the communication device. When the antenna having a double loop shape is mounted on the vehicle, it is necessary to secure a distance between the antenna and a body of the vehicle. Accordingly, when the antenna having a double loop shape is arranged on the windshield of the vehicle, it is difficult to secure the front vision of the driver.

### SUMMARY OF THE INVENTION

In view of the above-described problem, it is an object of the present disclosure to provide an in-vehicle antenna device. Even when the in-vehicle antenna device is arranged on a windshield of the vehicle, a front vision of a driver is sufficiently secured. Further, even when a communication device using the same communication frequency zone as the in-vehicle antenna device is disposed in a compartment of the vehicle, the communication device is not affected by the in-vehicle antenna.

According to an aspect of the present disclosure, an in-vehicle antenna device includes: a dielectric element having a front surface, first and second side surfaces and a rear surface, wherein a distance between the front surface and the rear surface is substantially equal to a product of one-fourth of a wavelength of an electromagnetic wave and a shortening ratio of the wavelength of the electromagnetic wave passing through the dielectric element, and wherein the dielectric element includes a power supply point disposed on both of the first and second side surfaces, a first conductive surface disposed on the first side surface, a second conductive surface disposed on the second side surface, and a third conductive surface disposed on the rear surface; and an antenna element including a base element and a branch element, wherein the base element is coupled with the power supply point at one corner of the front surface, wherein the branch element is connected to the base element and has an end opposite to the base element, and wherein a part of the branch element moves apart from one of the first and second conductive surfaces as it goes from the base element to the one end of the branch element. The front surface of the dielectric element is attached to a windshield of a vehicle near a corner, at which a roof and a pillar of the vehicle intersect.

In the above device, since the first and second conductive surfaces function as a ground, the area of the device is reduced so that a vision of a driver of the vehicle is appropriately secured. Further, since the third conductive surface functions as a reflection plate, the electromagnetic wave is restricted from being irradiated into a compartment of the vehicle. Even when a communication device using the same communication frequency zone as the in-vehicle antenna device is disposed in the compartment of the vehicle, the communication device is not affected by the in-vehicle antenna. Furthermore, a gain of the antenna device to an outside of the compartment is improved. Since the first and second conductive surfaces function as a reflection plate, the electromagnetic wave is restricted from being irradiated to a side of the vehicle.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram showing an in-vehicle antenna device on a windshield of a vehicle according to a first embodiment;

FIG. 2A is a diagram showing a perspective view of the in-vehicle antenna device viewed from a front side, and FIG. 2B is a diagram showing a perspective view of the in-vehicle antenna device viewed from a rear side;

FIG. 3A is a diagram showing a perspective view of the in-vehicle antenna device having no conductive surface on the rear side, FIG. 3B is a diagram showing a perspective view of the in-vehicle antenna device having a conductive surface on the rear side, FIG. 3C is a diagram showing a graph of a simulation result of a gain of the in-vehicle antenna device in FIG. 3A, and FIG. 3D is a diagram showing a graph of a simulation result of a gain of the in-vehicle antenna device in FIG. 3B;

FIG. 4 is a diagram showing a perspective view of an in-vehicle antenna device viewed from a front side according to a second embodiment;

FIG. 5 is a diagram showing a perspective view of an in-vehicle antenna device viewed from a front side according to a third embodiment;

FIG. 6 is a diagram showing a perspective view of an in-vehicle antenna device viewed from a front side according to a fourth embodiment; and

FIG. 7 is a diagram showing a cross sectional view of an in-vehicle antenna device according to a fifth embodiment.

### DETAILED DESCRIPTION OF THE PREFERRED EMBODIMENTS

### First Embodiment

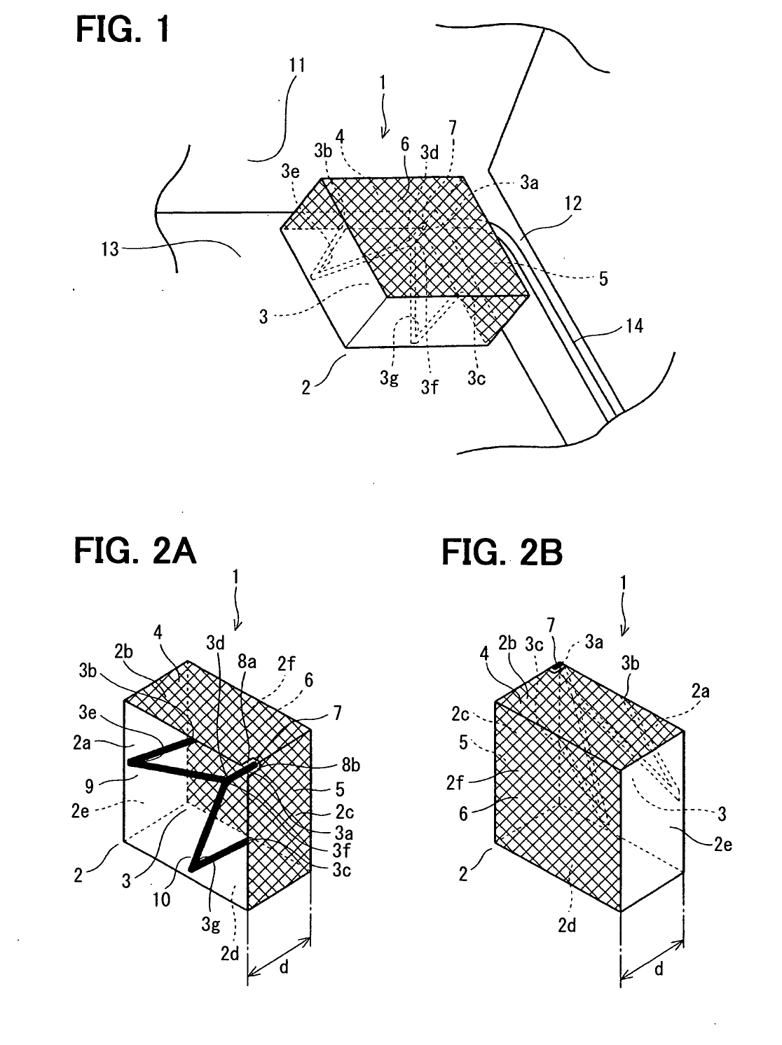

An in-vehicle antenna device 1 according to a first embodiment is shown in FIGS. 1 to 3D. The antenna device 1 includes a dielectric element 2 and an antenna element 3, which is formed on the dielectric element 2. The dielectric element 2 has a rectangular parallelepiped shape with a front surface 2a, four side surfaces 2b-2e and a rear surface 2f. A conductive member is arranged on two side surfaces 2b, 2c and the rear surface 2f so that three conductive surfaces 4-6 are formed. Each conductive surface 4-6 is hatched in FIGS. 1 and 2A-2B.

One conductive surface 4 is formed on almost all of the side surface 2b other than a part, which is disposed around a boundary between the side surface 2b and the side surface 2c. Another conductive surface 5 is formed on almost all of the side surface 2c other than a part, which is disposed around a boundary between the side surface 2b and the side surface 2c. Another conductive surface 6 is formed on all of the rear surface 2f. The conductive surfaces 4-6 are formed from a conductive foil such as a copper foil or a conductive paste such as silver paste.

A power supply point 7 is formed on the part of the side surface 2b, on which the conductive surface 4 is not formed, and the part of the side surface 2c, on which the conductive surface 5 is not formed, so that the power supply point 7 is disposed on both of the side surface 2b and the side surface 2c. The power supply point 7 and the conductive surface 4 are insulated from each other with an insulation region 8a, and the power supply point 7 and the conductive surface 5 are insulated from each other with an insulation region 8b. A height of the side surfaces 2b-2e is defined by d in FIGS. 2A and 2B. It is preferable that the height d is almost equal to a product of one-fourth of a wavelength of the used frequency of the electromagnetic wave and a shortening ratio of a wavelength of the electromagnetic wave passing through the dielectric element 2. The height d may be slightly different from the product within a predetermined allowance.

The antenna element 3 is formed on the front surface 2a of the dielectric element 2 such that the antenna element 3 is in parallel to a surface orientation of the rear surface 2f. The antenna element 3 includes one base antenna element 3a and two ends 3b, 3c such that the two ends 3b, 3c are branched from the base antenna element 3a. The antenna element 3 further includes a first antenna element 9 and a second antenna element 10. The first antenna element 9 has a L shape, which is branched from the base antenna element 3a toward the first end 3b. Specifically, the L shape of the first antenna element 9 has a bending portion 3d with an obtuse angle and another bending portion 3e with an acute angle. The second antenna element 10 has a L shape, which is branched from the base antenna element 3a toward the second end 3c. Specifically, the L shape of the second antenna element 10 has a bending portion 3f with an obtuse angle and another bending portion 3g with an acute angel. Thus, the base antenna element 3a is branched to the first and second antenna elements 9, 10.

A part of the first antenna element 9 between the base antenna element 3a and the bending portion 3e with the acute angel is separated from the conductive surface 4 on the side surface 2b as it goes from the base antenna element 3a to the bending portion 3e with the acute angel. A part of the second antenna element 10 between the base antenna element 3a and the bending portion 3g with the acute angel is separated from the conductive surface 5 on the side surface 2c as it goes from the base antenna element 3a to the bending portion 3g with the acute angel.

The base antenna element 3a is electrically coupled with the power supply point 7 at one corner of the front surface 2a. The first end 3b is electrically coupled with the conductive surface 4 on the side surface 2b at a middle point of the boundary between the side surface 2b and the front surface 2a. The second end 3c is electrically coupled with the conductive surface 5 on the side surface 2c at a middle point of the boundary between the side surface 2c and the front surface 2a. Thus, in the antenna element 3, the first antenna element 9 provides a loop shape, and the second antenna element 10 provides a loop shape. Thus, a double loop structure is formed, and the double loop structure has line-symmetry with reference to a line between the one corner of the front surface 2a and an opposing corner of the front surface 2a.

A first element length of the first antenna element 9 is defined as a length from the base antenna element 3a to the first end 3b. A second element length of the second antenna element 10 is defined as a length from the base antenna element 3a to the second end 3c. Each of the first and second element lengths is a half of the wavelength of the usage frequency of the electromagnetic wave. This length is designed in view of the shortening ratio of the wavelength of the electromagnetic wave as a whole. The shortening ratio is in a range between 0.7 and 0.8 according to the dielectric constant of glass of the windshield.

As shown in FIG. 1, the in-vehicle antenna device 1 is arranged near a corner, at which the roof 11 of the body of the vehicle and the pillar 12 intersect. Specifically, a whole of the front surface 2a of the dielectric element 2 contacts the windshield 13. The power supply cable 14 is coupled with the power supply point 7. In this case, the conductive surface 4 formed on the side surface 2b of the dielectric element 2 is grounded to the roof 11 of the vehicle body. The conductive surface 5 formed on the side surface 2c of the dielectric element 2 is grounded to the pillar 12 of the vehicle body.

Since the conductive surface 4 is formed on the side surface 2b of the dielectric element 2, and the conductive surface 5 is formed on the side surface 2c, and the conductive surfaces 4, 5 provide a ground, the area of the in-vehicle antenna device 1 in parallel to the front surface 2a and the rear surface 2f is reduced. When electric power is supplied to the power supply point 7 of the antenna element 3 via the cable 14, an electromagnetic wave is emitted to the outside of the compartment, i.e., the wave is emitted to the front direction of the vehicle since the antenna element 3 provides the double loop structure having a double loop surface along with a surface orientation of the front surface 2a of the dielectric element 2. Although the electromagnetic wave is also emitted to the inside of the compartment, i.e., the wave is emitted to the rear side of the vehicle, the wave is reflected on the conductive surface 6 formed on the rear surface 2f of the dielectric element 2 since the conductive surface 6 is formed on almost a whole of the rear surface 2f of the dielectric element 2. Thus, the reflected electromagnetic wave is radiated to the front direction of the vehicle. Further, the conductive surface 4 on the side surface 2b and the conductive surface 5 on the side surface 2c functions as not only the ground but also a reflection plate, so that the electromagnetic wave is restricted to be emitted to a side direction of the vehicle.

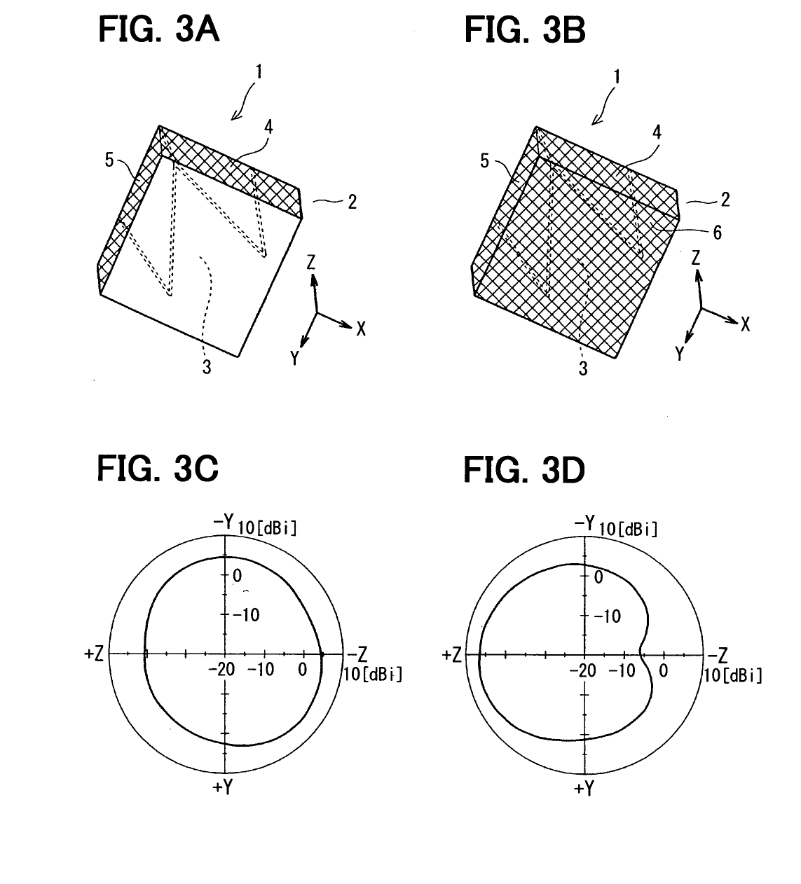

To estimate the gain in the front direction of the vehicle, a simulation experiment is performed. FIGS. 3A to 3D show a simulation result. FIGS. 3A and 3C show a simulation result of a case where only the conductive surfaces 4, 5 are formed on the dielectric element 2 without the conductive surface 6. Specifically, FIG. 3C show a directionality pattern of the in-vehicle antenna device 1 without the conductive surface 6 on the rear surface 2f. FIGS. 3B and 3D show a simulation result of a case where the conductive surfaces 4, 5, 6 are formed on the dielectric element 2. Specifically, FIG. 3D show a directionality pattern of the in-vehicle antenna device 1 with the conductive surface 6 on the rear surface 2f. When the conductive surface 6 is formed on the rear surface 2f, the gain in the rear direction, i.e., −Z direction in FIG. 3D, is reduced. Further, the gain in the front direction, i.e., +Z direction in FIG. 3D, is increased. Thus, the conductive surface 6 on the rear surface 2f functions as a reflection plate.

In the first embodiment, in the in-vehicle antenna device 1, the conductive surface 4 is formed on the side surface 2b of the dielectric element 2, and the conductive surface 5 is formed on the side surface 2c of the dielectric element 2. The conductive surfaces 4, 5 functions as the ground so that the area of the in-vehicle antenna device in parallel to the front surface 2a is reduced. Thus, the front vision of a driver of the vehicle is sufficiently secured even when the device 1 is mounted on the windshield of the vehicle. Further, the conductive surface 6 on the rear surface 2f of the dielectric element 2 functions as a reflection plate. Thus, the electromagnetic wave is restricted from being emitted to the rear direction of the vehicle, i.e., restricted from being radiated into the compartment of the vehicle. Thus, even when the communication device having the same communication frequency zone as the in-vehicle antenna device 1 is disposed in the compartment of the vehicle, the communication device is protected from the electromagnetic wave emitted from the antenna device 1. Further, the gain of the antenna device 1 in the front direction of the vehicle is improved. Furthermore, the conductive surface 4 on the side surface 2b and the conductive surface 5 on the side surface 2c of the dielectric element 2 functions as not only the ground but also the reflection plate of the electromagnetic wave. Thus, the emission of the electromagnetic wave in the side direction is restricted.

Since the dielectric element 2 is made of material having high dielectric constant, the dimensions of the antenna element 3 is minimized. Further, the thickness of the dielectric element 2, i.e., the height of the side surfaces 2b-2e, is reduced to be equal to or smaller than one-fourth of the wavelength of the usage frequency of the electromagnetic wave. Thus, the dimensions of the antenna device 1 are minimized.

### Second Embodiment

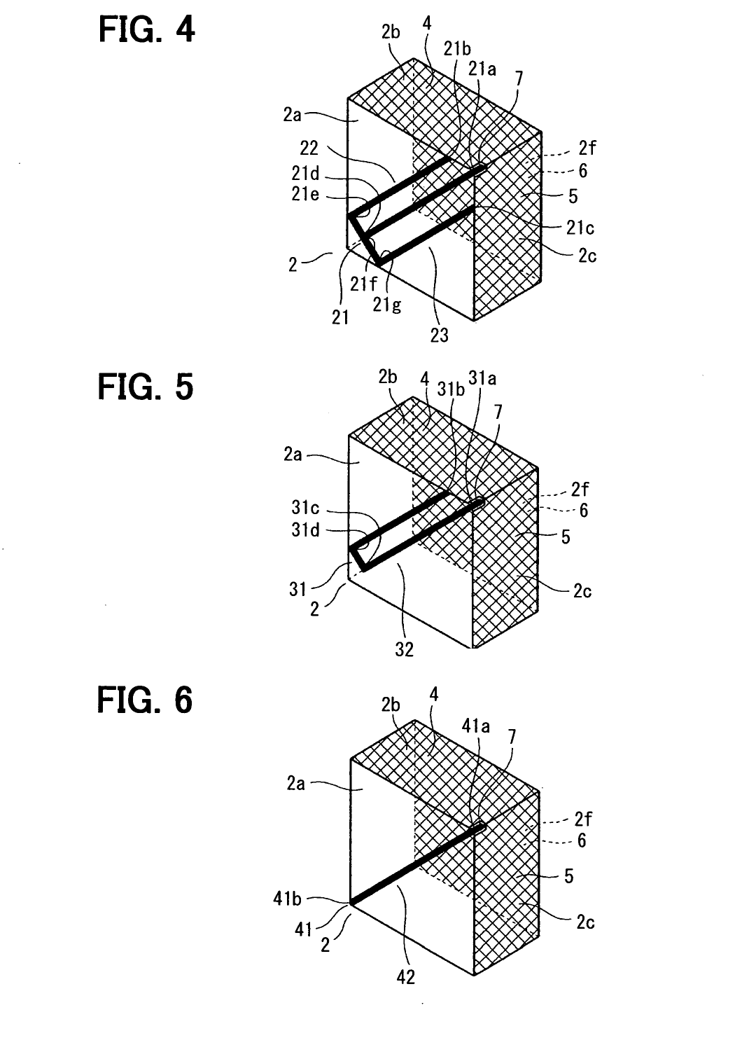

An in-vehicle antenna device 1 according to a second embodiment is shown in FIG. 4. A shape of the antenna element 21 in FIG. 4 is different from that in FIG. 2A. Specifically, the antenna element 21 includes one base antenna element 21a and two ends 21b, 21c such that the two ends 21b, 21c are branched from the base antenna element 21a. The antenna element 21 further includes a first antenna element 22 and a second antenna element 23. The first antenna element 22 has a U shape, which is branched from the base antenna element 21a toward the first end 21b. Specifically, the U shape of the first antenna element 22 has a bending portion 21d with a right angle and another bending portion 21e with a right angle. The second antenna element 23 has a U shape, which is branched from the base antenna element 21a toward the second end 21c. Specifically, the U shape of the second antenna element 23 has a bending portion 21f with a right angle and another bending portion 21g with a right angel. Thus, the base antenna element 21a is branched to the first and second antenna elements 22, 23.

A part of the first antenna element 22 between the base antenna element 21a and the bending portion 21d with the right angel is separated from the conductive surface 4 on the side surface 2b as it goes from the base antenna element 21a to the bending portion 21d with the acute angel. A part of the second antenna element 23 between the base antenna element 21a and the bending portion 21f with the right angel is separated from the conductive surface 5 on the side surface 2c as it goes from the base antenna element 21a to the bending portion 21f with the right angel.

The base antenna element 21a is electrically coupled with the power supply point 7 at one corner of the front surface 2a. The first end 21b is electrically coupled with the conductive surface 4 on the side surface 2b at the boundary between the side surface 2b and the front surface 2a. The second end 21c is electrically coupled with the conductive surface 5 on the side surface 2c at the boundary between the side surface 2c and the front surface 2a. Thus, in the antenna element 21, the first antenna element 22 provides a turn-back shape, i.e., a loop-back shape, and the second antenna element 10 provides a turn-back shape, i.e., a loop-back shape. Thus, a double loop structure is formed, and the double loop structure has line-symmetry with reference to a line between the one corner of the front surface 2a and an opposing corner of the front surface 2a.

A first element length of the first antenna element 22 is defined as a length, from the base antenna element 21a to the first end 21b. A second element length of the second antenna element 23 is defined as a length from the base antenna element 21a to the second end 21c. Each of the first and second element lengths is a half of the wavelength of the usage frequency of the electromagnetic wave. As shown in FIG. 4, the in-vehicle antenna device 1 is arranged near a corner, at which the roof 11 of the body of the vehicle and the pillar 12 intersect. Specifically, a whole of the front surface 2a of the dielectric element 2 contacts the windshield 13. The power supply cable 14 is coupled with the power supply point 7. Thus, the device in FIG. 4 provides the same effect as the device in FIG. 1.

### Third Embodiment

An in-vehicle antenna device 1 according to a third embodiment is shown in FIG. 5. A shape of the antenna element 31 in FIG. 5 is different from that in FIG. 2A. Specifically, the antenna element 31 includes one base antenna element 31a and one end 31b. The antenna element 31 further includes a antenna element portion 32. The antenna element portion 32 has a U shape, which, extends from the base antenna element 31a toward the one end 31b. Specifically, the U shape of the antenna element portion 32 has a bending portion 31c with a right angle and another bending portion 31d with a right angle. A part of the antenna element portion 32 between the base antenna element 31a and the bending portion 31c with the right angel is separated from the conductive surface 4 on the side surface 2b as it goes from the base antenna element 31a to the bending portion 31c with the acute angel. Further, the part of the antenna element portion 32 between the base antenna element 31a and the bending portion 31c with the right angel is separated from the conductive surface 5 on the side surface 2c as it goes from the base antenna element 31a to the bending portion 31c with the right angel.

The base antenna element 31a is electrically coupled with the power supply point 7 at one corner of the front surface 2a. The one end 31b is electrically coupled with the conductive surface 4 on the side surface 2b at the boundary between the side surface 2b and the front surface 2a. Thus, in the antenna element 21, the antenna element 31 provides a turn-back shape, i.e., a loop-back shape.

A element length of the antenna element portion 32 is defined as a length from the base antenna element 31a to the one end 31b. The element length is a half of the wavelength of the usage frequency of the electromagnetic wave. As shown in FIG. 5, the in-vehicle antenna device 1 is arranged near a corner, at which the roof 11 of the body of the vehicle and the pillar 12 intersect. Specifically, a whole of the front surface 2a of the dielectric element 2 contacts the windshield 13. The power supply cable 14 is coupled with the power supply point 7. Thus, the device in FIG. 5 provides the same effect as the device in FIG. 1.

### Fourth Embodiment

An in-vehicle antenna device 1 according to a fourth embodiment is shown in FIG. 6. A shape of the antenna element 41 in FIG. 6 is different from that in FIG. 2A. Specifically, the antenna element 41 includes one base antenna element 41a and one end 41b. The antenna element 41 further includes a antenna element portion 42. The antenna element portion 42 extends from the base antenna element 41a toward the one end 41b. Thus, a whole of the antenna element portion 42 between the base antenna element 41a and the one end 41b is separated from the conductive surface 4 on the side surface 2b as it goes from the base antenna element 41a to the one end 41b. Further, the whole of the antenna element portion 42 between the base antenna element 41a and the one end 41b is separated from the conductive surface 5 on the side surface 2c as it goes from the base antenna element 41a to the one end 41b.

The base antenna element 41a is electrically coupled with the power supply point 7 at one corner of the front surface 2a. The one end 41b is electrically opened. A element length of the antenna element portion 42 is defined as a length from the base antenna element 41a to the one end 41b. The element length is one-fourth of the wavelength of the usage frequency of the electromagnetic wave. As shown in FIG. 6, the in-vehicle antenna device 1 is arranged near a corner, at which the roof 11 of the body of the vehicle and the pillar 12 intersect. Specifically, a whole of the front surface 2a of the dielectric element 2 contacts the windshield 13. The power supply cable 14 is coupled with the power supply point 7. Thus, the device in FIG. 6 provides the same effect as the device in FIG. 1.

### Fifth Embodiment

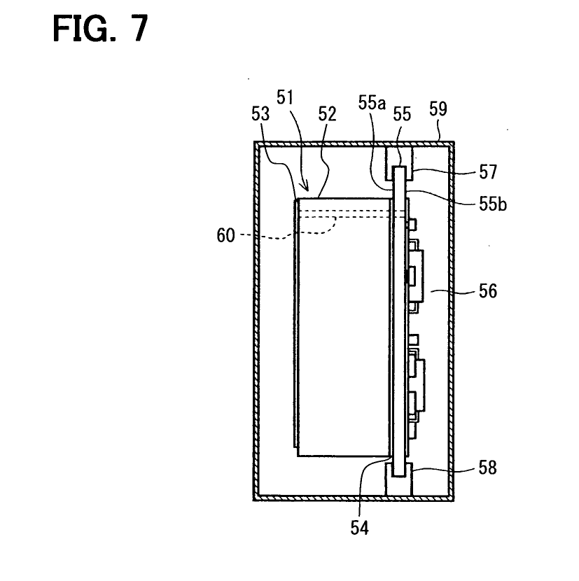

An in-vehicle antenna device 51 according to a fifth embodiment is shown in FIG. 7. A front end circuit 56 is integrated with the in-vehicle antenna device 51. Specifically, in the device 51, an antenna element 53 is formed on a dielectric element 52. A conductive surface 54 is formed on a rear surface of the dielectric element 52. The device 51 is mounted on one surface 55a of a main substrate 55. In the dielectric element 52, the conductive surface is also formed on a side surface, similar to the device in FIG. 1.

The front end circuit 56 formed from various electric elements is mounted on the other surface 55b of the main substrate 55. The antenna device 51 and the front end circuit 56 are integrated with each other via the main substrate 55. The upper surface of the substrate 55 is supported on a substrate support element 57. The lower surface of the substrate 55 is supported on another substrate support element 58. Further, the substrate 55 is accommodated in a resin case 59. The antenna element 53 is energized via a power supply line 60, which penetrates the dielectric element 52 from a front end circuit side to an antenna element side. The device in FIG. 7 provides the same effect as the device in FIG. 1. Further, the front end circuit is integrated with the in-vehicle antenna device 51.

### Other Embodiments

In the above in-vehicle antenna device 1, 51, the antenna element 3, 21, 31, 41, 53 may include a bypass portion as a short-cut portion for short-circuiting a part of the element 3, 21, 31, 41, 53 so as to form multiple passages having different passage lengths. Alternatively, the antenna element 3, 21, 31, 41, 53 may include a large width portion having a large width so as to form multiple passages having different passage lengths. Thus, the antenna element 3, 21, 31, 41, 53 provide multiple different element lengths, so that the usage frequency zone is broadened.

The dielectric element may be made of material having transparency or translucence. Alternatively, the conductive surface may have a mesh structure so as to transmit light through the mesh structure. The resin case 59 may be transparent or translucent. Thus, even when the device 1, 51 is mounted on the windshield of the vehicle, the vision of the driver of the vehicle is sufficiently secured.

The antenna device 1, 51 may be mounted on a front windshield, a rear windshield or a side windshield of the vehicle. Multiple in-vehicle antenna devices 1, 51 may be mounted on the vehicle so that a diversity effect is obtained.

The above disclosure has the following aspects.

According to an aspect of the present disclosure, an in-vehicle antenna device includes: a dielectric element having a front surface, first and second side surfaces and a rear surface, wherein a distance between the front surface and the rear surface is substantially equal to a product of one-fourth of a wavelength of an electromagnetic wave and a shortening ratio of the wavelength of the electromagnetic wave passing through the dielectric element, and wherein the dielectric element includes a power supply point disposed on both of the first and second side surfaces, a first conductive surface disposed on the first side surface, a second conductive surface disposed on the second side surface, and a third conductive surface disposed on the rear surface; and an antenna element including a base element and a branch element, wherein the base element is coupled with the power supply point at one corner of the front surface, wherein the branch element is connected to the base element and has an end opposite to the base element, and wherein a part of the branch element moves apart from one of the first and second conductive surfaces as it goes from the base element to the one end of the branch element. The front surface of the dielectric element is attached to a windshield of a vehicle near a corner, at which a roof and a pillar of the vehicle intersect.

In the above, device, since the first and second conductive surfaces function as a ground, the area of the device is reduced so that a vision of a driver of the vehicle is appropriately secured. Further, since the third conductive surface functions as a reflection plate, the electromagnetic wave is restricted from being irradiated into a compartment of the vehicle. Even when a communication device using the same communication frequency zone as the in-vehicle antenna device is disposed in the compartment of the vehicle, the communication device is not affected by the in-vehicle antenna. Furthermore, a gain of the antenna device to an outside of the compartment is improved. Since the first and second conductive surfaces function as a reflection plate, the electromagnetic wave is restricted from being irradiated to a side of the vehicle.

Alternatively, the branch element may include a first branch element and a second branch element, which are branched from the base element. The one end includes a first end of the first branch element and a second end of the second branch element. The first end is coupled with the first conductive surface, and the second end is coupled with the second conductive surface. The antenna element provides a double loop structure or a double turn-back structure.

Alternatively, the one end may be coupled with one of the first and second conductive surfaces. The antenna element provides a loop structure or a turn-back structure.

Alternatively, the one end may be electrically isolated from the first and second conductive surfaces. The antenna element provides an open end structure.

Alternatively, the dielectric element may be made of material having transparency or translucence.

Alternatively, each of the first to third conductive surfaces may be transparent.

Alternatively, the first side surface may be adjacent to the second side surface. The power supply point is isolated from the first and second conductive surfaces. The first branch element includes a first middle part, and the second branch element includes a second middle part. A distance between the first middle part and the first conductive surface increases as a position of the first branch element moves from the base element to the first end, and a distance between the second middle part and the second conductive surface increases as a position of the second branch element moves from the base element to the second end.

Alternatively, the first branch element may have a first element length, which is equal to a half of the wavelength of the electromagnetic wave, and the second branch element may have a second element length, which is equal to a half of the wavelength of the electromagnetic wave. The double loop structure or a double turn-back structure has a line-symmetry with reference to a line between the one corner of the front surface and an opposing corner of the front surface.

Alternatively, the first branch element may further include a first top part, and the second branch element includes a second top part. An angle between the base element and the first middle part is an obtuse angle, and an angle between the base element and the second middle part is an obtuse angle, and an angle between the first middle part and the first top part is an acute angle, and an angle between the second middle part and the second top part is an acute angle.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. An in-vehicle antenna device comprising:
a dielectric element having a front surface, first and second side surfaces and a rear surface, wherein a distance between the front surface and the rear surface is substantially equal to a product of one-fourth of a wavelength of an electromagnetic wave and a shortening ratio of the wavelength of the electromagnetic wave passing through the dielectric element, and wherein the dielectric element includes a power supply point disposed on both of the first and second side surfaces, a first conductive surface disposed on the first side surface, a second conductive surface disposed on the second side surface, and a third conductive surface disposed on the rear surface; and
an antenna element including a base element and a branch element, wherein the base element is coupled with the power supply point at one corner of the front surface, wherein the branch element is connected to the base element and has an end opposite to the base element, and wherein a part of the branch element moves apart from one of the first and second conductive surfaces as it goes from the base element to the one end of the branch element,
wherein the front surface of the dielectric element is attached to a windshield of a vehicle near a corner, at which a roof and a pillar of the vehicle intersect.

2. The in-vehicle antenna device according to claim 1,
wherein the branch element includes a first branch element and a second branch element, which are branched from the base element,
wherein the one end includes a first end of the first branch element and a second end of the second branch element,
wherein the first end is coupled with the first conductive surface, and the second end is coupled with the second conductive surface, and
wherein the antenna element provides a double loop structure or a double turn-back structure.

3. The in-vehicle antenna device according to claim 1,
wherein the one end is coupled with one of the first and second conductive surfaces, and
wherein the antenna element provides a loop structure or a turn-back structure.

4. The in-vehicle antenna device according to claim 1,
wherein the one end is electrically isolated from the first and second conductive surfaces, and
wherein the antenna element provides an open end structure.

5. The in-vehicle antenna device according to claim 1,
wherein the dielectric element is made of material having transparency or translucence.

6. The in-vehicle antenna device according to claim 1,
wherein each of the first to third conductive surfaces is transparent.

7. The in-vehicle antenna device according to claim 2,
wherein the first side surface is adjacent to the second side surface,
wherein the power supply point is isolated from the first and second conductive surfaces,
wherein the first branch element includes a first middle part, and the second branch element includes a second middle part,
wherein a distance between the first middle part and the first conductive surface increases as a position of the first branch element moves from the base element to the first end, and
wherein a distance between the second middle part and the second conductive surface increases as a position of the second branch element moves from the base element to the second end.

8. The in-vehicle antenna device according to claim 7,
wherein the first branch element has a first element length, which is equal to a half of the wavelength of the electromagnetic wave,
wherein the second branch element has a second element length, which is equal to a half of the wavelength of the electromagnetic wave, and
wherein the double loop structure or a double turn-back structure has a line-symmetry with reference to a line between the one corner of the front surface and an opposing corner of the front surface.

9. The in-vehicle antenna device according to claim 8,
wherein the first branch element further includes a first top part, and the second branch element includes a second top part,
wherein an angle between the base element and the first middle part is an obtuse angle, and an angle between the base element and the second middle part is an obtuse angle, and
wherein an angle between the first middle part and the first top part is an acute angle, and an angle between the second middle part and the second top part is an acute angle.
